(19) United States
(12) Patent Application Publication
(10) Pub. No.: US 2009/0265270 A1
(43) Pub. Date: Oct. 22, 2009

(54) Token activation

(75) Inventor: Anantha L. Gangaraju, Balkampet (IN)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/148,453

(22) Filed: Apr. 18, 2008

(51) Int. Cl. G06Q 40/00

(52) U.S. Cl. 705/41

(57) ABSTRACT

A method of activating a taken at a self-service terminal is described. The method comprises receiving an active token (such as a financial card) from a customer. The terminal then authenticates the customer using the active token and an associated identifier, which may be a PIN. The terminal then receives an inactive token from the customer (such as a newly-issued card), and validates that the inactive token relates to the same customer as the active token. In the event of successful validation, the terminal then activates the inactive token, either directly or indirectly.

### FIELD OF INVENTION

The present invention relates to token activation, and particularly, but in no way limited to, activation of a financial card.

### BACKGROUND OF INVENTION

Financial cards, such as ATM cards, credit cards, bank cards, and the like, are provided to allow customers of the card issuer to make purchases without using cash. Financial cards typically require a user to know an associated secret number (a personal identification number (PIN) typically comprising four digits) prior to being able to withdraw cash from an ATM. Since anyone possessing a financial card can access funds if they know the associated PIN, it is imperative that the card issuer only provides the PIN to the true cardholder. This is typically achieved by the card issuer sending a new financial card in a separate mailing to the PIN, and by requiring the cardholder to activate the financial card, for example, by answering some security questions, prior to use of the financial card.

Although this process generally works quite well, it is expensive, time consuming to administer, and has security problems.

### SUMMARY OF INVENTION

Accordingly, the invention generally provides methods, systems, apparatus, and software for activating a token using a customer's current token.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a method of activating a token at a self-service terminal, the method comprising: receiving an active token from a customer; authenticating the customer using the active token and an associated identifier; receiving an inactive token from the customer; validating that the inactive token relates to the same customer as the active token; and, in the event of successful validation, activating the inactive token.

Activating the inactive token may be performed directly by the terminal (for example, by writing a PIN or PIN offset onto the token) or indirectly (for example, by sending a request to a remote host to activate the token).

The tokens may be cards, such as financial cards, loyalty cards, or the like.

The associated identifier may be a PIN, a biometric feature, answers to security questions, or the like.

Activating the inactive token may include allowing the customer to select a PIN for the inactive token or assigning a PIN to the inactive token.

The method may comprise the further step of retaining the inactive token in the event of an unsuccessful validation. Alternatively, the method may comprise the further step of returning the inactive token to the customer in the event of an unsuccessful validation.

The self-service terminal may be an automated teller machine (ATM). The self-service terminal may be part of a network of such terminals.

According to a second aspect there is provided a computer program for executing on a self-service terminal, the computer program being operable, when executed, to implement the steps of the first aspect.

By virtue of these, aspects, a customer having one financial card (such as an ATM card) can go to an ATM and use that financial card to activate a newly-received, but not yet activated, financial card. This reduces the need for the card issuer to provide call centers to confirm that the person trying to activate a newly-received card is the true cardholder.

These and other aspects will be apparent from the following specific description, given by way of example, with reference to the accompanying drawings.

### BRIEF DESCRIPTION OF THE DRAWINGS

FIG. 1 is a schematic view of a customer using a self-service terminal to implement a method according to one embodiment of the present invention;

FIG. 2 is a block diagram of a part (the controller) of the terminal of FIG. 1; and

FIG. 3 is a flowchart illustrating a card activation flow of an application executing on the controller of FIG. 2.

### DETAILED DESCRIPTION

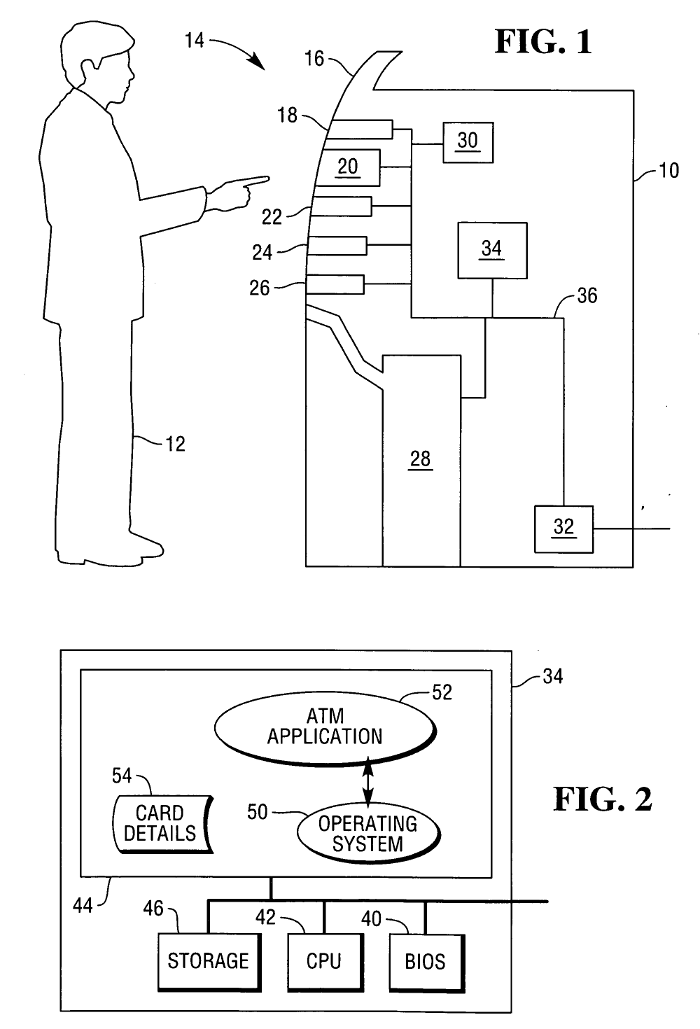

Reference is first made to FIG. 1, which is a side schematic view of a self-service terminal 10 (in the form of an ATM) being used by a customer 12 to implement a method according to one embodiment of the present invention.

The ATM 10 includes a user interface 14 for receiving input from, and outputting information to, the customer 12.

The user interface 14 comprises: a molded fascia 16 defining slots (not shown in detail) for accessing devices located within the ATM 10 and in registration with the slots; a display 20 aligned with opposing columns of function defined keys (FDKs); an encrypting keypad 22; a token reader 24, in the form of a motorized card reader/writer (MCRW) device; a printer 26; and a media dispenser 28 in the form of a cash dispenser.

The ATM 10 also includes an internal journal printer 30 for creating a record of all transactions executed by the ATM 10, a network connection 32 (in the form of a network card) for communicating with a remote transaction host (not shown) for authorizing transactions, and an ATM controller 34 for controlling the operation of the various devices (18 to 32).

The ATM controller 34 is shown in more detail in FIG. 2. The controller 34 comprises a BIOS 40 stored in non-volatile memory, a microprocessor 42, associated main memory 44, and storage space 46 in the form of a disk drive.

In use, the ATM 10 loads an operating system kernel 50 and an ATM application program 52 into the main memory 44. The ATM application program 52 includes conventional routines and objects for controlling the operation of the ATM 10, such as providing the sequence of screens used in each transaction (referred to as the application flow) and monitoring the condition of each device within the ATM 10 (state of health monitoring), as is known to those of skill in the art. In addition to these conventional functions, the ATM application program 52 includes a card activation routine.

Card Activation Transaction

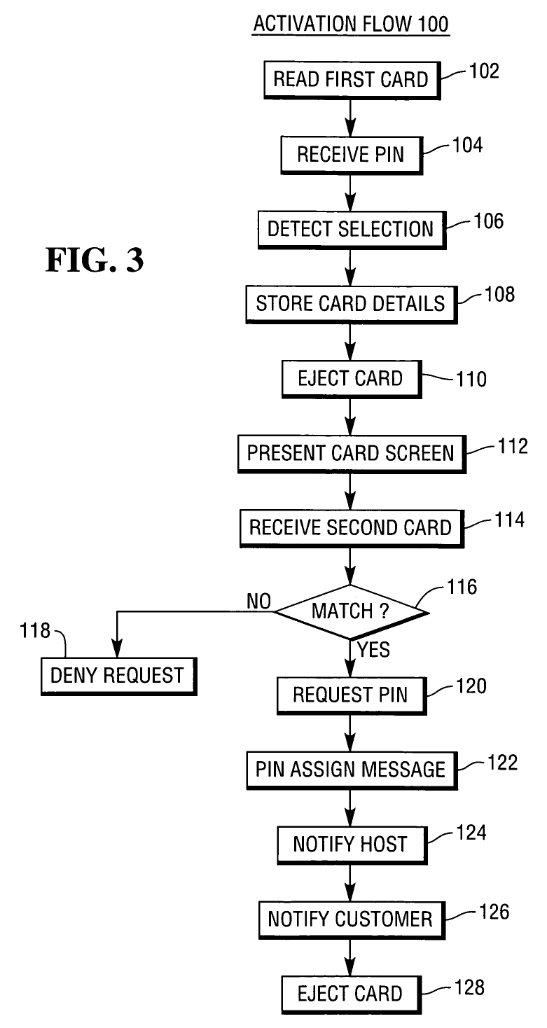

A typical card activation transaction will now be described with reference to FIG. 3, which is a flowchart illustrating a card activation flow 100 of the ATM application program 52.

When the customer 12 arrives at the ATM 10, the customer inserts his/her ATM card, which is read by the MCRW device 24 (step 102).

The ATM application program 52 then presents a screen inviting the customer 12 to enter his/her PIN. The customer 12 then types in his/her PIN, which is detected by the encrypting keypad 22 (step 104).

The ATM application program 52 then presents a list of transaction options on the display 20, including conventional transactions (cash withdrawal, statement printing, and the like) and a card activation transaction.

The customer 12 then requests the card activation transaction, for example, using the FDKs. This selection is detected by the ATM controller 34 (step 106). In response to this request, the ATM application program 52 stores information read from the ATM card in a temporary local file 54 (FIG. 2) (step 108) and then ejects the customer's ATM card (step 110).

Once the customer 12 has removed his/her ATM card, the ATM application program 52 then presents a card screen on the display 20 inviting the customer 12 to insert a financial card that is not yet activated (step 112).

The customer 12 inserts a new card that he/she has recently received (for example, by mail). The MCRW device 24 reads this new card (step 114), and compares the contents of this new card (for example, the customer's name) with the corresponding details read from the customer's ATM card and stored in temporary local file 54 (step 116).

If the details do not match, then the ATM application program 52 denies the request (step 118) and implements any actions predefined by the ATM owner or card issuer. For example, the ATM may notify the remote transaction host (not shown) that there has been a new card activation failure, and/or the MCRW may capture the new card.

If the details do match, then the ATM application program 52 requests the customer 12 to select a PIN for the new card (step 120), and in response to the entered PIN, the ATM application program 52 creates a PIN assignment message for transmission to the remote transaction host (not shown) (step 122).

The PIN assignment message includes the following encrypted information: the ATM card number used for the transaction, the entered PIN (or a PIN offset) associated with that ATM card, the new card number, and the selected PIN (or a PIN offset for the selected PIN) for the new card.

The ATM application program 52 then transmits the PIN assignment message to the remote transaction host (not shown) (step 124) and awaits confirmation of the PIN assignment and card activation.

The remote transaction host (not shown) receives and parses the PIN assignment message to ascertain if the ATM card number and PIN are correct for that customer. If the ATM card number and PIN combination is not correct, then the new card is not activated and the new PIN is not assigned. The remote transaction host (not shown) then transmits a transaction denial message to the ATM 10.

If the ATM card number and PIN combination is correct, then the new card is activated and the new PIN is assigned to that new card by the remote transaction host (not shown). The remote transaction host (not shown) then transmits a transaction confirmation message to the ATM 10.

The ATM 10 then presents the customer 12 with either a transaction denial message or a transaction confirmation message, depending on the response from the remote transaction host (not shown) (step 126).

If the transaction is confirmed, then the ATM 10 ejects the new card to the customer 12 (step 128), who can then use the new card for transactions.

It will now be appreciated that this embodiment has the advantage that where a financial institution issues multiple cards to the same customer, that customer can use an already activated card to activate a newly-received card, thereby avoiding the potential security problems associated with mailing a PIN to the customer, and also decreasing the amount of work done by a call centre that would otherwise have to ask security questions to activate the newly-issued card.

Various modifications may be made to the above described embodiment within the scope of the invention, for example, in other embodiments, the token may not be a card, it may be key fob, a ring, or the like.

In other embodiments, a biometric reading may be provided as the token or as the identifier associated with the token. In other embodiments, answers to security questions, or the like, may be used to authenticate the identity of the customer.

In other embodiments, a card other than a financial card may be used, for example, a loyalty card, a telephone card, or the like.

In other embodiments the self-service terminal may activate the new card directly, for example, by storing the newly-selected PIN (or an offset thereof) on the new card.

In other embodiments, the self-service terminal may actually issue a new card to the customer so that no card has to be mailed to the customer.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

What is claimed is:

1. A method of activating a token at a self-service terminal, the method comprising:
receiving an active token from a customer;
authenticating the customer using the active token and an associated identifier;
receiving an inactive token from the customer;
validating that the inactive token relates to the same customer as the active token; and,
in the event of successful validation, activating the inactive token.

2. A method according to claim 1, wherein activating the inactive token includes assigning a secret code to the token.

3. A method according to claim 2, wherein assigning a secret code to the token includes assigning a personal identification number to the token.

4. A method according to claim 3, wherein assigning the personal identification number to the token is performed in response to receiving a requested personal identification number from the customer.

5. A method according to claim 1, wherein the inactive token is a card.

6. A method according to claim 1, wherein the active token is a card.

7. A method according to claim 1, wherein the method comprises the further step of retaining the inactive token in the event of an unsuccessful validation.

8. A method according to claim 1, wherein the method comprises the further step of returning the inactive token to the customer in the event of an unsuccessful validation.

9. A method according to claim 1, wherein activating the inactive token includes the sub-step of requesting a remote host to activate the inactive token.

10. A computer program for executing on a self-service terminal, the computer program being operable, when executed, to implement the steps of claim 1.
